(19) United States
(12) Patent Application Publication
(10) Pub. No.: US 2013/0049575 A1
(43) Pub. Date: Feb. 28, 2013

(54) PHOSPHOR COMPOSITE MEMBER, LED DEVICE AND METHOD FOR MANUFACTURING PHOSPHOR COMPOSITE MEMBER

(71) Applicants: Shunsuke Fujita, Otsu-shi (JP); Ryota Suzuki, Otsu-shi (JP); Tadahito Furuyama, Otsu-shi (JP)

(72) Inventors: Shunsuke Fujita, Otsu-shi (JP); Ryota Suzuki, Otsu-shi (JP); Tadahito Furuyama, Otsu-shi (JP)

(21) Appl. No.: 13/696,240

(22) PCT Filed: Jun. 29, 2011
(86) PCT No.: PCT/JP2011/064922

§ 371 Date: Nov. 5, 2012

(30) Foreign Application Priority Data
Jul. 14, 2010 (JP) 2010-159448
Feb. 4, 2011 (JP) 2011-022347
Jun. 21, 2011 (JP) 2011-136917

(51) Int. Cl. B32B 17/06; B32B 37/24; B32B 33/00; H05B 33/14; B32B 18/00

(52) U.S. Cl. 313/503; 428/428; 428/427; 428/141; 156/62.2

(57) ABSTRACT

Provided is a phosphor composite member having excellent thermal resistance, high color rendition, controllability of various chromaticities from a daylight color to a light bulb color, and high luminescence intensity. A phosphor composite member in which a sintered inorganic powder body layer containing a SnO—P₂O₅-based glass and an inorganic phosphor powder is formed on a surface of a ceramic base material, wherein upon irradiation with an excitation light, the ceramic base material and the sintered inorganic powder body layer emit different fluorescences having different wavelengths.

### TECHNICAL FIELD

The present invention relates to a phosphor composite member for emitting a fluorescence by irradiation of an excitation light and providing a white light by synthesis of the excitation light penetrating it and the fluorescence, an LED device, and a method for manufacturing the phosphor composite member.

### BACKGROUND ART

As a result of development of a blue light emitting diode (LED), a complete set of LEDs covering the three primary colors, RGB (R: red, G: green, and B: blue), of light have been available. Thus, a technique is proposed for producing a white light with the use of these LEDs arranged side by side. However, because the LEDs of the three colors generally have different luminescence outputs, it is difficult to obtain a white light by adjusting the characteristics of the LEDs of the different colors. Furthermore, even if the LEDs of the three primary colors are collected and arranged in the same plane, a homogeneous white light source cannot be obtained when these LEDs are observed at close range as in an application as a backlight for an LCD, for example. In addition, because the LEDs of the different colors have different rates of color degradation, there arises a problem with the long-term stability of the white light.

To solve the above problems, an LED has developed in which a blue LED is combined with a YAG phosphor (Y₃Al₅O₁₂) for emitting a yellow fluorescence with a blue light emitted from the blue LED (see, for example, Patent Literature 1). This LED can provide a white light by synthesis of a yellow light emitted by the YAG phosphor and a transmitted light of the blue LED. This system uses a single kind of LED as an excitation light source and is, therefore, low in cost and excellent in long-term stability of the white light.

The above white LED has advantages, including long life, high efficiency, high stability, low power consumption, high response speed, and free from substances of environmental concern, over conventional light sources, such as illuminating devices, and is therefore now being applied to LCD backlights of almost all cellular phones. Furthermore, in recent years, the above white LED is rapidly spreading as a light source for an LCD backlight of a television set. In the future, the white LED is being expected to be also applied to generic illumination in addition to the above applications.

The white LED disclosed in Patent Literature 1 has a structure in which the light-emitting surface of an LED chip is molded and coated with an organic binder resin containing a phosphor powder dispersed therein. Therefore, the organic binder resin will be degraded and discolored by high-output, short-wavelength light in the blue to ultraviolet regions, heat production of the phosphor or heat from the LED chip. As a result, there arises a problem in that a decrease in luminescence intensity and color deviation occur to shorten the life time.

Furthermore, since the obtained white light is a light synthesized from blue and yellow lights, this presents a problem in that while a white light having a high color temperature (a daylight color) can be obtained, a white light having a low color temperature (a light bulb color) cannot be obtained. Moreover, since the light is a light synthesized from two colors, it has low color rendition and is therefore not suitable for illumination purpose.

To cope with the above problems, a phosphor composite member is proposed in which a sintered glass body layer containing an inorganic phosphor powder is formed on a surface of a ceramic base material for emitting a fluorescence (see, for example, Patent Literature 2). Since the phosphor composite member uses no organic binder resin having poor thermal resistance, it can reduce the decrease in luminescence intensity with time, exhibit high color rendition, and provide white lights corresponding to various color temperatures ranging from a daylight color to a light bulb color.

### CITATION LIST

### Patent Literature

Patent Literature 1: JP-A 2000-208815
Patent Literature 2: JP-A 2008-169348
Patent Literature 3: JP-A 2000-208815
Patent Literature 4: JP-A 2003-258308
Patent Literature 5: JP-A 2007-48864
Patent Literature 6: JP-A 2008-169348

### SUMMARY OF INVENTION

### Technical Problem

In the phosphor composite member described in Patent Literature 2, a SiO₂—B₂O₃-based glass is used as the glass powder contained in the sintered glass body layer and a base material containing YAG crystals is used as the ceramic base material. SiO₂—B₂O₃-based glasses generally have high melting points and, therefore, a high firing temperature (for example, 850° C. or more) is required to make a sintered glass body layer from such a glass. Hence, some phosphors used may be thermally degraded during firing to decrease the luminescence intensity. Furthermore, because SiO₂—B₂O₃-based glasses have a refractive index as low as about 1.6, the refractive index difference from the YAG substrate having a refractive index of above 1.8 is large, so that a light scattering loss will be likely to occur at the interface between the glass and the YAG substrate. As a result, the luminescence intensity of the resultant white light tends to decrease.

Hence, the present invention has an object of providing a phosphor composite member having excellent thermal resistance, high color rendition, controllability of various chromaticities from a daylight color to a light bulb color, and high luminescence intensity.

### Solution to Problem

The inventors have found from various studies that the above problems can be solved if in a phosphor composite member in which a sintered inorganic powder body layer containing a glass powder and an inorganic phosphor powder is formed on a surface of a ceramic base material for emitting a fluorescence, the glass powder used is a glass powder having a specific composition, and they propose the phosphor composite member as the present invention.

Specifically, a first phosphor composite member according to the present invention is a phosphor composite member in which a sintered inorganic powder body layer containing a SnO—P₂O₅-based glass and an inorganic phosphor powder is formed on a surface of a ceramic base material, wherein upon irradiation with an excitation light, the ceramic base material and the sintered inorganic powder body layer emit different fluorescences having different wavelengths.

In the first phosphor composite member of the present invention, since no organic material, such as an organic binder resin used in a conventional member, is used, the decrease in luminescence intensity with time can be reduced. In addition, since upon irradiation with an excitation light the ceramic base material and the sintered inorganic powder body layer emit different fluorescences having different wavelengths and these fluorescences are synthesized with the excitation light penetrating through the phosphor composite member, the phosphor composite member can exhibit high color rendition and emit white lights corresponding to various color temperatures ranging from a daylight color to a light bulb color.

Furthermore, in the first phosphor composite member of the present invention, a SnO—P₂O₅-based glass is used as a glass component constituting part of the sintered inorganic powder body layer. SnO—P₂O₅-based glasses can be easily decreased in softening point by optimizing their composition and therefore can be decreased in sintering temperature. Thus, the inorganic phosphor powder can be prevented from being degraded by the heat during firing. Moreover, SnO—P₂O₅-based glasses can achieve a refractive index as high as about 1.8 by optimizing their composition. Therefore, with the use of a YAG ceramic base material as the ceramic base material, such a SnO—P₂O₅-based glass can match in refractive index with the YAG ceramic base material, so that the light scattering loss at the interface between the ceramic base material and the sintered inorganic powder body layer can be reduced. As a result, a phosphor composite member having high luminescence intensity can be obtained, which is suitable as a member for an LED device which is used for an illuminating device, a light emitting device for a display or the like, or a headlight for a motor vehicle or the like.

Note that the term “-based glass” in the present invention refers to a glass containing the specified components as essential components.

The first phosphor composite member of the present invention may be characterized in that the ceramic base material absorbs an excitation light in a wavelength range of 400 to 500 nm and emits a fluorescence in a wavelength range of 450 to 780 nm.

The first phosphor composite member of the present invention may be characterized in that the ceramic base material absorbs a blue excitation light and emits a yellow fluorescence.

The first phosphor composite member of the present invention may be characterized in that the ceramic base material is made of garnet crystals containing Ce³⁺ in the crystal.

The first phosphor composite member of the present invention may be characterized in that the garnet crystal is a YAG crystal or a YAG crystalline solid solution.

The first phosphor composite member of the present invention may be characterized in that the sintered inorganic powder body layer absorbs an excitation light in a wavelength range of 400 to 500 nm and emits a fluorescence in a wavelength range of 500 to 780 nm.

The first phosphor composite member of the present invention may be characterized in that the sintered inorganic powder body layer absorbs a blue excitation light and emits a red fluorescence and/or a green fluorescence.

In the present invention, a blue light refers to a light having a central wavelength between 430 nm and 480 nm, a green light refers to a light having a central wavelength between 500 nm and 535 nm, a yellow light refers to a light having a central wavelength between 535 nm and 590 nm, and a red light refers to a light having a central wavelength between 610 nm and 780 nm.

The first phosphor composite member of the present invention may be characterized in that the fluorescences emitted from the ceramic base material and the sintered inorganic powder body layer and the excitation light penetrating through the phosphor composite member are synthesized to emit a white light.

The first phosphor composite member of the present invention may be characterized in that the sintered inorganic powder body layer contains the inorganic phosphor powder in a proportion of 0.01% to 30% by mass.

The first phosphor composite member of the present invention may be characterized in that the SnO—P₂O₅-based glass contains as a composition 35% to 80% by mole SnO, 5% to 40% by mole P₂O₅, and 0% to 30% by mole B₂O₃.

The first phosphor composite member of the present invention may be characterized in that the sintered inorganic powder body layer has a surface roughness Ra of 0.5 μm or less.

The first phosphor composite member of the present invention may be characterized in that the phosphor composite member has a scattering coefficient of 1 to 500 cm⁻¹.

An LED device according to the present invention uses any one of the above phosphor composite members.

A first method for manufacturing a phosphor composite member according to the present invention is a method for manufacturing any one of the above phosphor composite members and includes the steps of: firing a mixture of a SnO—P₂O₅-based glass and an inorganic phosphor powder to obtain a sintered body; and pressing the sintered body against the ceramic base material by thermocompression bonding to form a sintered inorganic powder body layer. Note that herein, for convenience, this manufacturing method refers to a “thermocompression bonding process” in distinction from a paste process and a green sheet process.

With the thermocompression bonding process, the sintered inorganic powder body layer is likely to be firmly bonded to the ceramic base material and can be prevented from peeling off at the interface.

Furthermore, SnO—P₂O₅-based glasses have relatively low mechanical strength and are brittle. Therefore, it is difficult to form from such a glass a very thin (for example, about 0.1 mm thick) sintered inorganic powder body layer using a general polishing method. On the other hand, with the use of the thermocompression bonding process, a very thin sintered inorganic powder body layer can be easily formed.

If the sintered body layer is formed by a paste process or a green sheet process, a carbon component derived from a solvent, a binder or the like may remain in the sintered body, which may cause a decrease in luminescence intensity. In contrast, with the thermocompression bonding process, the sintered inorganic powder body layer can be formed on the ceramic base material even without using any organic compound, such as a solvent or a binder. Therefore, a decrease in luminescence intensity due to a carbon component can be prevented.

A second method for manufacturing a phosphor composite member according to the present invention includes the steps of: placing a powder mixture containing a glass powder and an inorganic phosphor powder on an inorganic base material; and press molding the powder mixture with application of heat using a mold to form a sintered inorganic powder body layer on a surface of the inorganic base material.

If a sintered glass body layer containing an inorganic phosphor powder is formed on an inorganic base material by a paste process or a green sheet process, a carbon component derived from an organic resin, an organic solvent or the like may remain in the sintered body, which may cause a decrease in luminescence intensity. In contrast, with the second method for manufacturing a phosphor composite member according to the present invention, a powder mixture containing a glass powder and an inorganic phosphor powder can be pressed and fusion bonded directly to a surface of an inorganic base material without addition of any organic resin, any organic solvent or the like. Therefore, there is no problem of decrease in luminescence intensity caused by a carbon component derived from an organic resin, an organic solvent or the like. Hence, a luminescent color conversion member having excellent luminescence intensity can be obtained.

Furthermore, since there is no need to make material powders into a paste or a green sheet and a powder mixture can be used for press molding as it is, the manufacturing process can be simplified. In addition, a very thin sintered inorganic powder body layer can be easily formed on a surface of an inorganic base material.

In the second method for manufacturing a phosphor composite member of the present invention, the inorganic base material is preferably made of YAG-based ceramic, crystallized glass, glass, metal or metal-ceramic composite.

In the second method for manufacturing a phosphor composite member of the present invention, the sintered inorganic powder body layer preferably has a thickness of 0.3 mm or less.

The thinning of the sintered inorganic powder body layer can reduce the light scattering loss in the sintered inorganic powder body layer, so that the luminescence intensity of the phosphor composite member can be increased.

In the second method for manufacturing a phosphor composite member of the present invention, the sintered inorganic powder body layer preferably has a surface roughness (Ra) of 0.5 μam or less.

With this configuration, the light scattering loss at the surface of the sintered inorganic powder body layer can be reduced, so that the excitation light and the fluorescence will be likely to penetrate the sintered inorganic powder body layer. As a result, the luminescence intensity of the phosphor composite member can be increased.

In the second method for manufacturing a phosphor composite member of the present invention, the glass powder preferably has an average particle diameter (D₅₀) of 100 μm or less.

With this configuration, the dispersed condition of the inorganic phosphor powder in the phosphor composite member can be improved, so that variations in luminescent color can be reduced.

In the second method for manufacturing a phosphor composite member of the present invention, the proportion of the inorganic phosphor powder in the sintered inorganic powder body layer is preferably 0.01% to 90% by mass.

In the second method for manufacturing a phosphor composite member of the present invention, the sintered inorganic powder body layer preferably contains 0% to 30% by mass inorganic filler.

The addition of inorganic filler into the sintered inorganic powder body layer can reduce the difference in expansion coefficient from the inorganic base material to prevent the occurrence of peel-off and cracks.

In the second method for manufacturing a phosphor composite member of the present invention, the glass powder is preferably a SiO₂—B₂O₃—RO-based glass powder (where R is one or more elements selected from Mg, Ca, Sr, and Ba), a SiO₂—TiO₂—Nb₂O₅—R′₂O-based glass powder (where R′ is one or more elements selected from Li, Na, and K), a SnO—P₂O₅-based glass powder, or a ZnO—B₂O₃—SiO₂-based glass powder.

In the second method for manufacturing a phosphor composite member of the present invention, the SnO—P₂O₅-based glass powder preferably contains as a glass composition 35% to 80% by mole SnO, 5% to 40% by mole P₂O₅, and 0% to 30% by mole B₂O₃.

In the second method for manufacturing a phosphor composite member of the present invention, the inorganic phosphor powder is preferably an oxide, a nitride, an oxynitride, a sulfide, an oxysulfide, an oxyfluoride, a halide, an aluminate, or a halophosphoric acid chloride.

In the second method for manufacturing a phosphor composite member of the present invention, the temperature during press molding is preferably 900° C. or below.

Thus, thermal deactivation of the inorganic phosphor powder and thermal denaturation of the glass powder can be prevented.

In the second method for manufacturing a phosphor composite member of the present invention, the atmosphere during press molding is preferably air, vacuum, nitrogen or argon.

In the second method for manufacturing a phosphor composite member of the present invention, the shape of the phosphor composite member is preferably a sheet-like shape, a hemispherical shape, or a hemispherical domed shape.

A second phosphor composite member of the present invention is produced by any one of the above manufacturing methods.

### BRIEF DESCRIPTION OF DRAWINGS

FIG. 1 is a schematic view showing a phosphor composite member of a first embodiment.

FIG. 2 is schematic views showing a method for manufacturing a phosphor composite member of a second embodiment.

### DESCRIPTION OF EMBODIMENTS

### First Embodiment

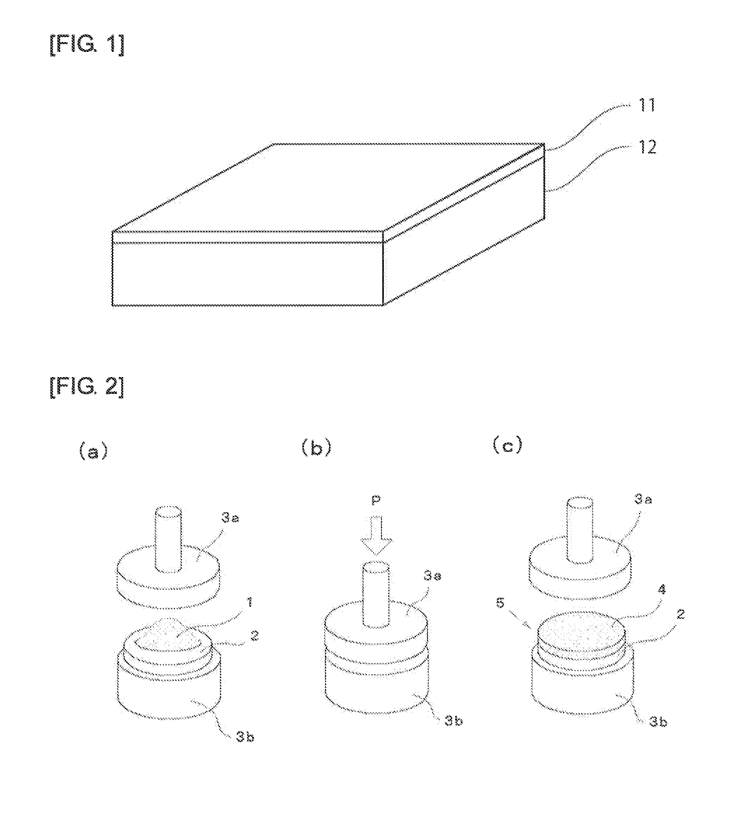

FIG. 1 shows a schematic view of a phosphor composite member of this embodiment. As shown in FIG. 1, the phosphor composite member of this embodiment is made so that a sintered inorganic powder body layer 11 containing a SnO—P₂O₅-based glass and an inorganic phosphor powder is formed on a surface of a ceramic base material 12 and is characterized in that upon irradiation with an excitation light, the ceramic base material 12 and the sintered inorganic powder body layer 11 emit different fluorescences having different wavelengths.

Specifically, in the phosphor composite member of this embodiment, upon irradiation with an excitation light, the ceramic base material 12 preferably absorbs a light in a wavelength range of 400 to 500 nm (preferably a blue light) and emits a fluorescence in a wavelength range of 450 to 780 nm (preferably a yellow fluorescence). On the other hand, the sintered inorganic powder body layer 11 preferably absorbs a light in a wavelength range of 400 nm to 500 nm (preferably a blue light) and emits a fluorescence in a wavelength range of 500 nm to 780 nm (preferably a red fluorescence and/or a green fluorescence). Since the ceramic base material 12 and the sintered inorganic powder body layer 11 have the above absorption wavelengths and fluorescence wavelengths, a white light having a low color temperature (a light bulb color) can be easily obtained.

The preferred ceramic base material 12 used in the phosphor composite member of this embodiment is one made of garnet crystals containing Ce₂O₃ in a proportion of 0.001% to 1% by mole, preferably 0.002% to 0.5% by mole, and particularly preferably 0.005% to 0.2% by mole in the ceramic base material 12. Thus, Ce³⁺ becomes a luminescent center in the garnet crystal, so that the ceramic base material can easily absorb blue a blue excitation light and emit a yellow fluorescence. If the content of Ce₂O₃ in the ceramic base material 12 is too small, the yellow light luminescence intensity tends to decrease, resulting in difficulty in obtaining a white light. On the other hand, if the content of Ce₂O₃ is too large, a yellow fluorescence will be strong, resulting in difficulty in obtaining a white light.

Garnet crystals refer to crystals generally represented by A₃B₂C₃O₁₂ (A=Mg, Mn, Fe, Ca, Y, Gb or the like; B=A1, Cr, Fe, Ga, Sc or the like; and C=A1, Si, Ga, Ge or the like). Particularly preferred among the garnet crystals are a YAG (Y₃Al₅O₁₂) crystal or YAG crystalline solid solutions because they emit a desired yellow fluorescence. An example of the YAG crystalline solid solutions is one in which part of Y is substituted by at least one element selected from the group consisting of Gd, Sc, Ca, and Mg and, additionally or alternatively, part of Al is substituted by at least one element selected from the group consisting of Ga, Si, Ge, and Sc.

The ceramic base material 12 is preferably in the shape of a sheet having a thickness of 0.01 to 2 mm, more preferably 0.05 to 1 mm, and particularly preferably 0.1 to 0.5 mm. If the ceramic base material 12 is in the shape of a sheet, the sintered inorganic powder body layer 11 can be easily formed on the ceramic base material 12. If the thickness of the ceramic base material 12 is too small, the crystal content in the ceramic base material 12 will be small, so that a sufficient amount of yellow fluorescence cannot be emitted, resulting in difficulty in obtaining a white light. On the other hand, if the thickness of the ceramic base material 12 is too large, the luminescence intensity of the yellow light will be high, resulting in difficulty in obtaining a white light.

The ceramic base material 12 in this embodiment can be made, for example, in the following manner. First, oxide materials of A, B, and C are weighed to give a stoichiometric composition of A₃B₂C₃O₁₂ (where A=Mg, Mn, Fe, Ca, Y, Gd or the like; B=A1, Cr, Fe, Ga, Sc or the like; and C=A1, Si, Ga, Ge or the like) and 0.001% to 1% by mole Ce₂O₃ is added to these oxide materials. Next, these materials are well stirred and mixed by a ball mil or the like and the resultant powder is then press molded into a desired shape (for example, sheet-like shape) at a pressure of 100 to 300 MPa. Subsequently, the resultant press-molded body is fired at a temperature of 1500° C. to 1800° C. to obtain a ceramic base material 12. If an oxide material powder having a particle diameter of several micrometers or less and high purity is used, a homogeneous ceramic base material 12 can be easily obtained.

The SnO—P₂O₅-based glass powder used in the sintered inorganic powder body layer 11 serves as a medium for stably holding the inorganic phosphor powder. SnO—P₂O₅-based glass powders have low melting points, can be sintered at low temperatures and, therefore, can prevent thermal degradation of the inorganic phosphor powder during firing. Examples of such SnO—P₂O₅-based glass powders include SnO—P₂O₅—B₂O₂-based glasses and SnO—P₂O₅—ZnO-based glasses.

The preferred SnO—P₂O₅-based glass is one containing as a composition 35% to 80% by mole SnO, 5% to 40% by mole P₂O₅, and 0% to 30% by mole B₂O₃. The reasons why the glass composition is restricted as above are described below.

SnO is a component for forming the glass network and lowering the softening point. The content of SnO is preferably 35% to 80%, more preferably 40% to 70%, still more preferably 50% to 70%, and particularly preferably 55% to 65%. If the content of SnO is less than 35%, the glass softening point tends to rise and the weatherability tends to degrade. On the other hand, if the content of SnO is above 80%, devitrified products derived from Sn tend to be precipitated in the glass to decrease the glass transmittance, resulting in decreased fluorescence intensity. In addition, the glass will be difficult to vitrify.

P₂O₅ is a component for forming the glass network. The content of P₂O₅ is preferably 5% to 40%, more preferably 10% to 30%, and particularly preferably 15% to 24%. If the content of P₂O₅ is less than 5%, the glass will be difficult to vitrify. On the other hand, if the content of P₂O₅ is above 40%, the glass softening point tends to rise and the weatherability tends to significantly decrease.

In order to lower the softening point and stabilize the glass, the value of SnO/P₂O₅ in molar ratio is preferably from 0.9 to 16, more preferably from 1.5 to 16, still more preferably from 1.5 to 10, and particularly preferably from 2 to 5. If the value of SnO/P₂O₅ is smaller than 0.9, the glass softening point tends to rise and the sintering temperature tends to rise. As a result, the inorganic phosphor powder will be likely to be degraded by a thermal treatment during the formation of an inorganic phosphor powder layer. In addition, the glass weatherability tends to significantly decrease. On the other hand, if the value of SnO/P₂O₅ is greater than 16, devitrified products derived from Sn tend to be precipitated in the glass to decrease the glass transmittance, resulting in difficulty in obtaining a phosphor composite member having a high luminescence efficiency.

B₂O₃ is a component for increasing the glass weatherability and inhibiting the reaction between the glass powder and the inorganic phosphor powder. B₂O₃ is also a component for stabilizing glass. The content of B₂O₃ is preferably 0% to 30%, more preferably 1% to 25%, still more preferably 2% to 20%, and particularly preferably 4% to 18%. If the content of B₂O₃ is above 30%, the weatherability will be likely to decrease. In addition, the glass softening point tends to rise.

The SnO—P₂O₅-based glass powder can be doped with other components described below.

Al₂O₃ is a component for stabilizing glass. The content of Al₂O₃ is preferably 0% to 10%, more preferably 0% to 7%, and particularly preferably 1% to 5%. If the content of Al₂O₃ is above 10%, the glass softening point tends to rise and the sintering temperature tends to rise. As a result, the inorganic phosphor powder will be likely to be degraded by a thermal treatment during the formation of an inorganic phosphor powder layer.

SiO₂ is, like Al₂O₃, a component for stabilizing glass. The content of SiO₂ is preferably 0% to 10%, more preferably 0% to 7%, and particularly preferably 0.1% to 5%. If the content of SiO₂ is above 10%, the glass softening point tends to rise and the sintering temperature tends to rise. As a result, the inorganic phosphor powder will be likely to be degraded by a thermal treatment during the formation of an inorganic phosphor powder layer. In addition, the glass will be likely to be separated in phase.

Li₂O, Na₂O, and K₂O are components for lowering the glass softening point. The content of each component is preferably 0% to 10%, more preferably 0% to 7%, and particularly preferably 0.1% to 5%. If the content of each of these components is above 10%, the glass will be significantly unstable and will be difficult to vitrify.

Note that the total amount of Li₂O, Na₂O, and K₂O is preferably 0% to 10%, more preferably 0% to 7%, and particularly preferably 1% to 5%. If the total amount of these components is above 10%, the glass will be unstable and will be difficult to vitrify.

MgO, CaO, SrO, and BaO are components for stabilizing glass to facilitate vitrification. The content of each component is preferably 0% to 10%, more preferably 0% to 7%, and particularly preferably 0.1% to 5%. If the content of each of these components is above 10%, the glass will be likely to be devitrified and the glass transmittance tends to decrease. As a result, the luminescence intensity will be likely to decrease.

Note that the total amount of MgO, CaO, SrO, and BaO is preferably 0% to 10%, more preferably 0% to 7%, and particularly preferably 1% to 5%. If the total amount of these components is above 10%, the glass will be likely to be devitrified and the glass transmittance tends to decrease. As a result, the luminescence intensity will be likely to decrease.

Furthermore, in order to increase the weatherability, ZnO, Ta₂O₅, TiO₂, Nb₂O₅, Gd₂O₂ and/or La₂O₂ may be added up to 10% in total.

The refractive index (nd) of the SnO—P₂O₅-based glass powder is preferably not less than 1.5, more preferably not less than 1.7, and particularly preferably not less than 1.8 from the viewpoint of reducing the light scattering loss at the interface between the ceramic substrate and the sintered inorganic powder body layer 11.

The softening point of the SnO—P₂O₅-based glass powder is preferably not higher than 500° C., more preferably not higher than 450° C., and particularly preferably not higher than 400° C. If the softening point is above 500° C., the sintering temperature will be high, so that the inorganic phosphor powder will be likely to be degraded by a thermal treatment during the formation of an inorganic phosphor powder layer.

Furthermore, if the average particle diameter D₅₀ of the SnO—P₂O₅-based glass powder is too large, the inorganic phosphor powder in the sintered inorganic powder body layer 11 will be in a poor dispersed condition and the luminescent color will be likely to vary. Therefore, the average particle diameter D₅₀ of the SnO—P₂O₅-based glass powder is preferably not more than 100 μm and particularly preferably not more than 50 μm. Note that although no particular limitation is placed on the lower limit of the average particle diameter D₅₀ of the SnO—P₂O₅-based glass powder, it is preferably not less than 0.1 μm and particularly preferably not less than 1 μm because an excessively low average particle diameter D₅₀ thereof will be likely to raise the cost.

Any inorganic phosphor powder can generally be used as the inorganic phosphor powder contained in the sintered inorganic powder body layer 11 so long as it is commercially available, and examples of such inorganic phosphor powders include oxides, nitrides, oxynitrides, sulfides, oxysulfides, oxyfluorides, halides, and halophosphoric acid chlorides. Among them, those having an excitation range in a wavelength range of 300 to 500 nm and having a luminescence peak in a wavelength range of 500 to 780 nm, and in particular those for emitting a red light and/or a green light are preferably used.

Specifically, examples of the inorganic phosphor powders which emit a red fluorescence upon irradiation with a blue excitation light include CaS:Eu²⁺; ZnS:Mn²⁺, Te²⁺; Mg₂TiO₄:Mn⁴⁺; K₂SiF₆:Mn⁴⁺; SrS:Eu²⁺; Na_{1.23}K_{0.42}Eu_{0.12}TiSi4₄O₁₁; Na_{1.23}K_{0.42}Eu_{0.12}TiSi₅O₁₃:Eu³⁺, CdS:In,Te; CaAlSiN₃:Eu²⁺; CaSiN₃:Eu²⁺; (Ca, Sr)₂Si₅N₈: Eu²⁺; and Eu₂W₂O₇.

Furthermore, examples of the inorganic phosphor powders which emits a green fluorescence upon irradiation with a blue excitation light include SrAl₂O₄:Eu²⁺; SrGa₂S₄:Eu²⁺; SrBaSiO₄:Eu²⁺; CdS:In; CaS:Ce³⁺; Y₃(Al,Gd)₅O₁₂:Ce²⁺; Ca₃Sc₂Si₃O₁₂:Ce³⁺; and SrSiO_{N}:Eu²⁺.

If the content of inorganic phosphor powder in the sintered inorganic powder body layer 11 is too large, this presents problems, including difficulty in sintering, increase in porosity, and increase in light scattering loss. On the other hand, if the content of inorganic phosphor powder is too small, this will make it difficult to provide a sufficient luminescence. Therefore, the content of inorganic phosphor powder in the sintered inorganic powder body layer 11 is preferably 0.01% to 30% by mass, more preferably 0.05% to 20% by mass, and particularly preferably 0.08% to 15% by mass.

The sintered inorganic powder body layer 11 preferably has a thickness of 0.01 to 1 mm, more preferably 0.02 to 0.8 mm, and particularly preferably 0.1 to 0.8 mm. If the thickness of the sintered inorganic powder body layer 11 is less than 0.01 mm, the luminescence emitted from the sintered inorganic powder body layer 11 will be insufficient, resulting in difficulty in obtaining a white light. On the other hand, if the thickness of the sintered inorganic powder body layer 11 is above 1 mm, the excitation light and the fluorescence emitted by the ceramic substrate will be less likely to be transmitted, resulting in difficulty in obtaining a white light.

Note that when the ceramic base material 12 is in the shape of a sheet, the sintered inorganic powder body layer 11 may be formed only on one side of the ceramic base material 12 or on both sides thereof.

In the phosphor composite member of this embodiment, the scattering coefficient is preferably 1 to 500 cm⁻¹, more preferably 2 to 250 cm⁻¹, and particularly preferably 10 to 200 cm⁻¹. If the scattering coefficient is less than 1 cm⁻¹, the excitation light will not be well scattered in the phosphor composite member and the majority thereof will penetrate through the phosphor composite member. As a result, sufficient fluorescences will not be emitted in the ceramic substrate and the sintered inorganic powder body layer 11 to lower the excitation efficiency, so that the luminescence intensity will be likely to decrease. On the other hand, if the scattering coefficient is large, the excitation light will largely scatter in the phosphor composite member to increase the amount of fluorescence emitted and thereby increase the excitation efficiency; however, if the scattering coefficient is above 500 cm⁻¹, the light scattering loss tends to be too large to decrease the luminescence intensity.

Furthermore, in the phosphor composite member of this embodiment, the surface roughness Ra of the sintered inorganic powder body layer 11 is preferably not more than 0.5 μm, more preferably not more than 0.2 μm, and particularly preferably not more than 0.1 μm. If the surface roughness of the sintered inorganic powder body layer 11 is above 0.5 μm, the light scattering loss will be large to decrease the transmittance of excitation light and fluorescence, so that the luminescence intensity tends to decrease.

The phosphor composite member of this embodiment is preferably made, without interposition of any adhesive layer or any space layer between the ceramic base material 12 and the sintered inorganic powder body layer 11, by integrally fusion bonding the sintered inorganic powder body layer 11 onto the ceramic base material 12 to bring them into close contact with each other. The provision of such a close contact structure without any space between the ceramic base material 12 and the sintered inorganic powder body layer 11 enables reduction of the light scattering loss at the interface between the ceramic base material 12 and the sintered inorganic powder body layer 11, reduction of the decrease in luminescence intensity, and improvement in mechanical strength. Furthermore, in this manner, it becomes possible to make the phosphor composite member of this embodiment even without the use of any organic resin adhesive which would cause thermal discoloration.

In order to prevent peel-off of the sintered inorganic powder body layer 11 from the ceramic base material 12, the following preferably holds: −5 ppm/° C.≦α1−α2≦1 ppm/° C., particularly −1 ppm/° C.≦α1−α2≦1 ppm/° C., where α1 represents the coefficient of thermal expansion of the ceramic base material 12 and α2 represents the coefficient of thermal expansion of the sintered inorganic powder body layer 11. If (α1−α2) is out of the above range, the sintered inorganic powder body layer 11 will be likely to be peeled off from the ceramic base material 12.

In order to match the expansion coefficient of the ceramic base material 12 with that of the sintered inorganic powder body layer 11, the sintered inorganic powder body layer 11 preferably contains an inorganic filler powder. Examples of the inorganic filler powder include zirconium phosphate, zirconium phosphotungstate, zirconium tungstate, NZP crystals, and solid solutions of them, all having low expansion properties, and these filler powders can be used singularly or as a mixture. The term “NZP crystals” herein includes crystals having a fundamental structure of Nbzr(PO₄)₃ or [AB₂(MO₄)₃], for example.

A: Li, Na, K, Mg, Ca, Sr, Ba, Zn, Cu, Ni, Mn or the like;

B: Zr, Ti, Sn, Nb, Al, Sc, Y or the like; and

M: P, Si, W, Mo or the like.

The preferred inorganic filler powder used is one containing a Zr component. The inorganic filler powder containing a Zr component has the characteristic of good compatibility to SnO—P₂O₅-based glasses, i.e., low reactivity with SnO—P₂O₅-based glasses, to make the glass less likely to be devitrified during sintering.

The coefficient of thermal expansion of the inorganic filler powder is, within a temperature range of 30° C. to 380° C., preferably not more than 50×10⁻⁷/° C. and particularly preferably not more than 30×10⁻⁷/° C. If the coefficient of thermal expansion of the inorganic filler powder is greater than 50×10⁷/° C., this will make it difficult to obtain the effect of reducing the coefficient of thermal expansion of the sintered inorganic powder body layer 11. Note that although no particular limitation is placed on the lower limit of the coefficient of thermal expansion of the inorganic filler powder, it is actually −100×10⁻⁷/° C. or more.

The content of inorganic filler powder in the sintered inorganic powder body layer 11 is preferably 1% to 30% by mass, more preferably 1.5% to 25% by mass, and particularly preferably 2% to 20% by mass. If the content of inorganic filler powder is less than 1% by mass, the above effect will be difficult to achieve. On the other hand, if the content of inorganic filler powder is above 30% by mass, the content of glass powder softened and flowing during firing will be relatively small, so that the strength of fusion to the ceramic base material 12 will be likely to decrease. Furthermore, the light scattering loss at the interfaces between the glass matrix and the inorganic filler powder particles in the sintered inorganic powder body layer 11 will be large, so that the luminescence intensity tends to decrease.

The average particle diameter D₅₀ of the inorganic filler powder is preferably 0.1 to 50 μm and particularly preferably 3 to 20μm. If the average particle diameter D₅₀ of the inorganic filler powder is smaller than 0.1 μm, the effect of reducing the coefficient of thermal expansion tends to be poor. Otherwise, the inorganic filler powder may be dissolved in glass during firing and may not serve as a filler. If the average particle diameter D₅₀ of the inorganic filler powder is greater than 50 μm, cracks will be likely to occur at the boundary between the SnO—P₂O₅-based glass powder and the inorganic filler powder.

The smaller the difference in refractive index between the inorganic filler powder and SnO—P₂O₅-based glass powder, the smaller the light scattering loss at the interface between them will be and the more the luminescence intensity will be improved. Specifically, the difference in refractive index between the inorganic filler powder and SnO—P₂O₅-based glass powder is preferably not more than 0.2 and particularly preferably not more than 0.1. For example, when the refractive index of the SnO—P₂O₅-based glass is about 1.8, the refractive index of the inorganic filler powder is preferably 1.6 to 2 and particularly preferably 1.7 to 1.9.

The sintered inorganic powder body layer 11 can be made by adding a binder, a plasticizer, a solvent, and others to a mixture containing a SnO—P₂O₅-based glass powder, an inorganic phosphor powder, and, as needed, an inorganic filler, kneading them, making the resultant mixture into a paste, for example, and firing the paste. The proportion in the whole paste accounted for by the glass powder and inorganic phosphor powder is generally about 30% to about 90% by mass.

The binder is a component for increasing the strength of the film after being dried and giving the film flexibility and its content is generally about 0.10 to about 20% by mass. Examples of the binder include polybutyl methacrylate, polyvinyl butyral, polymethyl methacrylate, polyethyl methacrylate, ethyl cellulose, and nitrocellulose and these binders can be used singularly or as a mixture.

The plasticizer is a component for controlling the drying speed of the film and giving the dried film flexibility and its content is generally about 0% to about 10% be mass. Examples of the plasticizer include dibutyl phthalate, butyl benzyl phthalate, dioctyl phthalate, diisooctyl phthalate, dicapryl phthalate, and dibutyl phthalate and these plasticizers can be used singularly or as a mixture.

The solvent is a component for making the material powders into a paste and its content is generally about 10% to about 50% by mass. Examples of the solvent include terpineol, isoamyl acetate, toluene, methyl ethyl ketone, diethylene glycol monobutyl ether acetate, 2,2,4-trimethyl-1,3-pentadiol monoisobutyrate, and 2,4-diethyl-1,5-pentanediol and these solvents can be used singularly or as a mixture.

An intended sintered inorganic powder body layer 11 can be obtained by coating the paste onto the ceramic base material 12, such as using screen printing, coating, or dispensing, to form a coated layer with a predetermined film thickness, drying the coated layer, and then firing it. In this case, the sintered inorganic powder body layer 11 may be formed instead by pressing a heating plate against the paste and applying a pressure to the paste.

The firing temperature is preferably 250° C. to 600° C. and particularly preferably 300° C. to 500° C. If the firing temperature is below 250° C., the sintered inorganic powder body layer 11 will be likely to be peeled off from the ceramic base material 12. In addition, a dense sintered inorganic powder body layer 11 will be difficult to obtain, resulting in decreased luminescence intensity of the sintered inorganic powder body layer 11 and thereby difficulty in obtaining a phosphor composite member capable of emitting a desired light. On the other hand, if the firing temperature is above 600° C., the inorganic phosphor powder will be degraded by reaction with the glass powder, so that a phosphor composite member capable of emitting a desired light will be difficult to obtain.

The firing atmosphere is preferably a reduced-pressure or vacuum atmosphere or an atmosphere of inert gas, such as nitrogen or argon in order to reduce oxidation in the glass powder, particularly oxidation of a Sn component. If the Sn component in the glass powder is oxidized, the glass powder will be less likely to sinter and the fusion thereof to the ceramic substrate tends to be insufficient.

The sintered inorganic powder body layer 11 can be made using, aside from the paste, a green sheet. A general method for making a green sheet is to prepare the above glass powder, inorganic phosphor powder, binder, plasticizer and others, adding a solvent to these materials into a slurry, and form the slurry into a sheet on a film made such as of polyethylene terephthalate (PET) by a doctor blade method. Subsequently, after the formation of the sheet, the sheet is dried to remove the organic solvent and the like, whereby a green sheet can be provided.

The proportion in the green sheet accounted for by the glass powder and inorganic phosphor powder is generally about 50% to about 80% by mass.

Examples of the binder, the plasticizer, and the solvent that can be used are the same as those described previously. The mixture ratio of the binder is generally about 0.1% to about 30% by mass, the mixture ratio of the plasticizer is generally about 0% to about 10% by mass, and the mixture ratio of the solvent is generally about 1% to 40% by mass.

The sintered inorganic powder body layer 11 can be obtained by laying the green sheet obtained in the above manner on the ceramic base material 12, bonding the green sheet to the ceramic base material 12 by thermocompression, and then firing them in the same manner as in the above case of the paste.

Alternatively, the sintered inorganic powder body layer 11 can also be formed by previously making a sintered body by firing a mixture of a SnO—P₂O₅-based glass and an inorganic phosphor powder and then pressing the sintered body against the ceramic base material 12 by thermocompression bonding. The thermocompression bonding is performed, for example, by holding the ceramic base material 12 and the sintered body between heated mold halves. The thermocompression bonding may be performed with a mold release, such as a glass substrate, inserted between the mold and the sintered body.

In the above method, a very thin (for example, 0.01 to 0.30 mm thick) sintered inorganic powder body layer 11 can be easily formed as described previously.

No particular limitation is placed on the pressing temperature so long as it is the temperature that allows the SnO—P₂O₅-based glass to be well softened and firmly adhere to the surface of the ceramic base material 12. Specifically, the temperature is preferably not lower than 200° C. and particularly preferably not lower than 250° C. Although no particular limitation is placed on the upper limit of the pressing temperature, it is preferably not higher than 900° C., more preferably not higher than 700° C., and particularly preferably not higher than 500° C. from the viewpoint of preventing deactivation of the inorganic phosphor powder and denaturation of the SnO—P₂O₅-based glass.

The pressure of the pressing is appropriately adjusted within the range of not less than 30 kPa/cm² or the range of not less than 50 kPa/cm² depending upon the desired thickness of the sintered inorganic powder body layer 11. On the other hand, although no particular limitation is placed on the upper limit of the pressure, it is preferably not more than 400 kPa/cm² and particularly preferably not more than 300 kPa/cm² in order to prevent breakage of the phosphor composite member.

Although no particular limitation is placed on the pressing time, it may be appropriately adjusted preferably between 0.1 and 30 minutes, more preferably between 0.5 and 10 minutes, and particularly preferably between 1 and 5 minutes in order that the sintered inorganic powder body layer 11 can sufficiently adhere to the surface of the ceramic base material 12.

In order to prevent deactivation of the inorganic phosphor powder, denaturation of the SnO—P₂O₅-based glass, and degradation of the pressing apparatus due to oxidation, the atmosphere during thermocompression bonding is preferably an inert gas atmosphere, particularly a nitrogen atmosphere in consideration of running cost.

The phosphor composite member of this embodiment may be produced by previously making only the sintered inorganic powder body layer 11, then placing the sintered inorganic powder body layer 11 on the ceramic base material 12, and heating them to a temperature near the softening point of the sintered inorganic powder body layer 11 to integrally fusion bond them to each other.

The phosphor composite member produced in the above manner may be cut and polished into a given shape, such as disc-like, columnar, rod-like or other shapes.

### EXAMPLES

Hereinafter, the phosphor composite member of the present invention will be described in detail with reference to examples, but is not limited to the examples.

### Example 1

### (1) Production of Ceramic Base Material

First, materials having high purity and a particle diameter of 2 μm or less were used, i.e., 37.4625% by mole Y₂O₃, 62.5% by mole Al₂O₃, and 0.0375% by mole Ce₂O₃ were weighed to give a stoichiometric composition of YAG (Y₃Al₅O₁₂) and 0.6% by mass tetraethoxy silane was added as a sintering additive to these materials. Next, using a ball mil, the prepared materials were mixed with stirring in ethanol for 17 hours, then reduced in pressure, and dried to obtain a powder. Subsequently, the resultant powder was press-molded at a pressure of 200 MPa to make a press molded body having a diameter of 10 mmφ and a thickness of 3 mm, and the press molded body was fired at 1750° C. for 10 hours in a vacuum atmosphere to obtain a fired body. Thereafter, the fired body was polished at both surfaces to have a thickness of 0.1 mm, thereby obtaining a ceramic base material.

The ceramic base material thus obtained was identified in terms of its precipitated crystals using an X-ray powder diffractometer. As a result, it was confirmed that YAG crystals were precipitated in a single phase.

The obtained ceramic base material was measured in terms of luminescence spectra. As a result, peaks were observed which were derived from a yellow fluorescence having a center wavelength near 550 nm and a blue excitation light (an excitation light having penetrated the ceramic base material) having a center wavelength near 465 nm.

The luminescence spectra were measured in the following manner. The ceramic base material was excited, in a calibrated integrating sphere, by a blue LED illuminated by an electric current of 600 mA and the resultant luminescence was retrieved through an optical fiber into a small spectrometer (USB4000 manufactured by Ocean Optics, Inc.) to obtain luminescence spectra (an energy distribution curve) on a control PC.

### (2) Production of Paste for Sintered Inorganic Powder Body Layer

Glass materials prepared to give a composition of 62% by mole SnO, 21.5% by mole P₂O₅, 11% by mole B₂O₃, 3% by mole MgO, 2.5% by mole Al₂O₃ were put into an alumina crucible and melted at 950° C. for an hour in an electric furnace and in a nitrogen atmosphere. Thereafter, the glass melt was formed into a film and then ground by a mortar to obtain a glass powder.

Next added to the produced glass powder were CaS:Eu²⁺ as an inorganic phosphor powder and NbZr (PO₄)₃ as an inorganic filler powder to give amass ratio of 80:10:10, followed by mixing with a vibrational mixer. Added to 100 mass parts of the obtained powder mixture was 50 mass parts of 2,4-diethyl-1,5-pentanediol (MARS manufactured by The Nippon Koryo Yakuhin Kaisha, Ltd.) as a solvent, followed by mixing to obtain a paste.

A sintered inorganic powder body layer was produced using the above paste and the produced layer was measured in terms of luminescence spectra. As a result, peaks were observed which were derived from a red fluorescence having a center wavelength near 650 nm and a blue excitation light having a center wavelength near 465 nm.

The sintered inorganic powder body layer for measuring luminescence spectra was produced in the following manner. First, the paste was coated by coating on a porous mullite ceramic substrate to have a thickness of 50 μm and degreased at 300° C. for an hour. Next, the coating was fired at 400° C. for 30 minutes and then cooled and the mullite substrate was then removed to obtain a sintered inorganic powder body layer having a thickness of 40 μm.

### (3) Production of Phosphor Composite Member

The paste for the sintered inorganic powder body layer obtained in (2) above was coated by dispensing on a surface of the ceramic base material obtained in (1) above to have a thickness of approximately 50 μm. Next, the solvent was removed from the coating by subjecting the coating to thermal treatment on a hot plate at approximately 250° C. Thereafter, the coating was fired at 430° C. for 10 minutes in a nitrogen atmosphere and its surface shape was fixed by hot pressing against the sintered inorganic powder body layer to obtain a phosphor composite member. The thickness of the sintered inorganic powder body layer was approximately 20 μm.

The phosphor composite member thus obtained was measured in terms of luminescence spectra by the above method. Using a control software (OP Wave manufactured by Ocean Photonics), the total flux (lm) and the chromaticity were calculated from the resultant luminescence spectra. The results are shown in Table 1.

### Example 2

### (1) Production of Green Sheet for Sintered Inorganic Powder Body Layer

Added to the glass powder produced in Example 1 were SrS:Eu²⁺ (average particle diameter: 8 μm) and SrBaSiO₄:Eu²⁺ (average particle diameter: 8 μm) as inorganic phosphor powders to give a mass ratio of 94:3:3, followed by mixing to produce a powder mixture. Next added to 100 mass parts of the produced powder mixture were 12 mass parts of polyvinyl butyral resin as a binder, 3 mass parts of dibutyl phthalate as a plasticizer, and 40 mass parts of toluene as a solvent, followed by mixing to produce a slurry. Subsequently, the slurry was formed into a sheet on a PET film by a doctor blade method and then dried to obtain a green sheet having a thickness of 50 μm.

A sintered inorganic powder body layer produced using the green sheet was measured in terms of luminescence spectra in the same manner as in Example 1. As a result, peaks were observed which were derived from a green fluorescence having a center wavelength near 525 nm, a red fluorescence having a center wavelength near 650 nm, and a blue excitation light having a center wavelength near 465 nm.

The sintered inorganic powder body layer for measuring luminescence spectra was produced in the following manner. First, the green sheet produced in the above manner was laid on a porous mullite ceramic substrate and integrated together by thermocompression bonding to produce a laminate and the laminate was then degreased at 300° C. for an hour. Next, the laminate was fired at 400° C. for 30 minutes and then cooled and the mullite substrate was removed to obtain a sintered inorganic powder body layer having a thickness of 40 μm.

### (2) Production of Phosphor Composite Member

The green sheet produced in (1) above was laid on the ceramic base material obtained in Example 1 and integrated together by thermocompression bonding to produce a laminate and the laminate was then degreased at 350° C. for an hour. Next, the laminate was fired at 400° C. for 20 minutes and then cooled to obtain a phosphor composite member.

The phosphor composite member thus obtained was measured in terms of total flux and chromaticity in the same manner as described previously. The results are shown in Table 1.

### Example 3

### (1) Production of Sintered Body for Sintered Inorganic Powder Body Layer

Added to the glass powder obtained in Example 1 were CaAlSiN₃:Eu²⁺ as an inorganic phosphor powder and NbZr(PO₄)₃ as an inorganic filler powder to give a mass ratio of 80:10:10, followed by mixing with a vibrational mixer. The powder mixture was press molded and fired at 400° C. in vacuum to obtain a sintered body.

The obtained sintered body was measured in terms of luminescence spectra. As a result, peaks were observed which were derived from a red fluorescence having a center wavelength near 650 nm and a blue excitation light having a center wavelength near 465 nm.

Note that the sample for measuring luminescence spectra was produced by grinding the sintered body into a piece 8 mm square, then slicing the piece into a 1 mm thick slice, and mirror polishing both sides of the slice.

### (2) Production of Phosphor Composite Member

The sintered body for a sintered inorganic powder body layer obtained in (1) above was put on a surface of the ceramic base material obtained in Example 1 and they were pressed at a pressure of 100 kPa/cm² for 3 minutes on a hot plate at approximately 400° C. in a nitrogen atmosphere to obtain a phosphor composite member. The thickness of the sintered inorganic powder body layer was approximately 50 μm.

The phosphor composite member thus obtained was measured in terms of total flux and chromaticity in the same manner as described previously. The results are shown in Table 1.

### Comparative Example 1

### (1) Production of Paste for Sintered Inorganic Powder Body Layer

Glass materials prepared to give a composition of 60% by mole SiO₂, 5% by mole B₂O₃, 10% by mole CaO, 15% by mole BaO, 5% by mole Al₂O₃, and 5% by mole ZnO were put into a platinum crucible and melted at 1400° C. for two hours to obtain a homogeneous glass. Next, the glass was ground into particles with an alumina ball and the particles were classified to obtain a SiO₂—B₂O₃-based glass powder having an average particle diameter of 2.5 μm.

Next added to the produced glass powder were CaS:Eu²⁺ as an inorganic phosphor powder and NbZr (PO₄)₃ as an inorganic filler powder to give a mass ratio of 80:10:10, followed by mixing with a vibrational mixer. Added to 100 mass parts of the obtained powder mixture was 50 mass parts of 2,4-diethyl-1,5-pentanediol (MARS manufactured by The Nippon Koryo Yakuhin Kaisha, Ltd.) as a solvent, followed by mixing to obtain a paste.

### (2) Production of Phosphor Composite Member

The paste produced in (1) above was coated by dispensing on a surface of the ceramic base material obtained in Example 1 to have a thickness of 50 μm and degreased at 300° C. for an hour. Next, the coating was fired at 850° C. for 20 minutes to produce a phosphor composite member.

The phosphor composite member thus obtained was measured in terms of total flux and chromaticity in the same manner as described previously. The results are shown in Table 1.

TABLE 1

| | | Example 1 | Example 2 | Example 3 | Comp. Ex. 1 |
|---|---|---|---|---|---|
| Sintered | Glass | SnO—P₂O₅-based glass | SnO—P₂O₅-based glass | SnO—P₂O₅-based glass | SiO₂—B₂O₃-based glass |
| Inorganic | Powder | | | | |
| Powder | Inorganic | CaS:Eu²⁺ | SrS:Eu²⁺ | CaAlSiN₃:Eu²⁺ | CaS:Eu²⁺ |
| Body | Phosphor | | SrBaSiO₄:Eu²⁺ | | |
| Layer | Powder | | | | |

| | | | | |
|---|---|---|---|---|
| Ceramic Base | YAG | YAG | YAG | YAG |
| Material | | | | |
| Production Method | Paste process | Green sheet | Thermocompression | Paste process |
| of Sintered Inorganic | | process | bonding process | |
| Powder Body Layer | | | | |
| Chromaticity | x = 0.453 | x = 0.447 | x = 0.453 | x = 0.441 |
| | y = 0.405 | y = 0.402 | y = 0.409 | y = 0.395 |
| Total Flux | 18.7 | 18.3 | 18.5 | 10.4 |

It can be clearly seen from Table 1 that the phosphor composite members of Examples 1 and 2 provided white light of light bulb color and exhibited high luminescence intensities of 18.3 μm or more. On the other hand, the phosphor composite member of Comparative Example 1 provided a white light of light bulb color but exhibited a luminescence intensity as low as 10.4 μm.

### Second Embodiment

White LEDs have recently been attracting much attention as high efficiency, high reliability white light sources and have already been put into practical use. The white LEDs have advantages, including long life, high efficiency, high stability, low power consumption, high response speed, and free from substances of environmental concern, over conventional light sources, such as illuminating devices and is therefore rapidly spreading as LCD backlights of cellular phones and TV sets. In the future, the white LEDs are being expected to be also applied to generic illumination in addition to the above applications.

The white LED disclosed in Patent Literature 3 has a structure in which the light-emitting surface of an LED chip is molded and coated with an organic binder resin containing an inorganic phosphor powder dispersed therein. Therefore, the organic binder resin will be degraded and discolored by high-output, short-wavelength light in the blue to ultraviolet regions, heat production of the inorganic phosphor powder or heat from the LED chip. As a result, there arises a problem in that a decrease in luminescence intensity and color deviation occur to shorten the life time.

To cope with the above problems, a phosphor composite member is proposed which is obtained by mixing an inorganic phosphor powder and a glass powder and sintering them (see, for example, Patent Literature 4). Since the phosphor composite member is obtained by dispersing the inorganic phosphor powder in the inorganic glass powder having high thermal resistance, it can reduce the decrease in luminescence intensity with time. In Patent Literature 4, however, cutting and polishing processes are necessary to obtain a phosphor composite member of a desired size. For example, in order to obtain a thin phosphor composite member, it is necessary to once produce a relatively thick member by sintering an inorganic phosphor powder and a glass powder and then thin the member by cutting and polishing it. Therefore, this production method provides poor material yields of the inorganic phosphor powder and glass powder, resulting in tendency to raise the production cost of the phosphor composite member.

To cope with the above, a phosphor composite member is proposed in which a sintered glass body layer containing an inorganic phosphor powder is formed on a surface of an inorganic base material (see, for example, Patent Literature 5 or 6). The phosphor composite member is made so that a sintered body layer containing an inorganic phosphor powder is formed on an inorganic substrate by a paste processor a green sheet process. Therefore, a thin phosphor composite member can be produced without undergoing cutting, polishing and like processes.

The method described in Patent Literature 5 or 6 has a problem in that although a luminescent color conversion member having a desired shape can be produced in good yield, the luminescence intensity of the member is low. In addition, since the process for producing a paste or a green sheet is necessary, this presents a problem in that the production process is troublesome.

In view of these circumstances, this embodiment has an object of providing a method that can easily manufacture a phosphor composite member having higher luminescence intensity than conventional members.

FIG. 1 shows a schematic view of a method for manufacturing a phosphor composite member of the second embodiment.

First, referring to FIG. 1(a), an inorganic base material 2 is placed still on a lower mold half 3b and a predetermined amount of powder mixture 1 containing an inorganic phosphor powder and a glass powder is put on the inorganic base material 2.

Next, referring to FIG. 1(b), heat is applied to the powder mixture 1 while the powder mixture 1 is pressed using an upper mold half 3a, thereby sintering the powder mixture 1. Thus, as shown in FIG. 1(c), a phosphor composite member 5 can be obtained in which a sintered inorganic powder body layer 4 is formed on the inorganic base material 2. In this case, no particular limitation is placed on the heating method; the powder mixture may be pressed using a mold heated at a predetermined temperature or may be pressed in an atmosphere set at a predetermined temperature (for example, in an electric furnace).

Examples of the glass powder used in this embodiment includes SiO₂—B₂O₃—RO-based glass powders (where R is one or more elements selected from Mg, Ca, Sr, and Ba), SiO₂—TiO₂—Nb₂O₅—R′₂O-based glass powders (where R′ is one or more elements selected from Li, Na, and K), SnO—P₂O₅-based glass powders, and ZnO—B₂O₃—SiO₂-based glass powders. The use of, among them, SnO—P₂O₅-based glass powders having relatively low softening points is preferred, because the press molding temperature can be lowered and the inorganic phosphor powder can be prevented from deactivating.

The preferred SnO—P₂O₅-based glass powders are those containing a glass composition of 35% to 80% by mole SnO, 5% to 40% by mole P₂O₅, and 0% to 30% by mole B₂O₃. The reasons why the glass composition is restricted as above are described below.

SnO is a component for forming the glass network and lowering the softening point. The content of SnO is preferably 35% to 80%, more preferably 40% to 70%, still more preferably 50% to 70%, and particularly preferably 55% to 65%. If the content of SnO is too small, the glass softening point tends to rise and the weatherability tends to degrade. On the other hand, if the content of SnO is too large, devitrified products derived from Sn tend to be precipitated in the glass to decrease the glass transmittance, resulting in ease of decrease in luminescence intensity of the phosphor composite member 5. In addition, the glass will be difficult to vitrify.

P₂O₅ is a component for forming the glass network. The content of P₂O₅ is preferably 5% to 40%, more preferably 10% to 30%, and particularly preferably 15% to 24%. If the content of P₂O₅ is too small, the glass will be difficult to vitrify. On the other hand, if the content of P₂O₅ is too large, the glass softening point tends to rise and the weatherability tends to significantly decrease.

B₂O₃ is a component for increasing the weatherability and inhibiting the reaction between the glass powder and the inorganic phosphor powder. B₂O₃ is also a component for stabilizing glass. The content of B₂O₃ is preferably 0% to 30%, more preferably 1% to 25%, still more preferably 2% to 20%, and particularly preferably 4% to 18%. If the content of B₂O₃ is too large, the weatherability will be likely to decrease. In addition, the glass softening point tends to rise.

The preferred SiO₂—B₂O₃—RO-based glass powders are those containing a glass composition of 30% to 70% by mass SiO₂, 1% to 15% by mass B₂O₃, 0% to 10% by mass MgO, 0% to 25% by mass CaO, 0% to 10% by mass SrO, 8% to 40% by mass BaO, 10% to 45% by mass MgO+CaO+SrO+BaO, 0% to 20% by mass Al₂O₃, and 0% to 10% by mass ZnO.

The preferred SiO₂—TiO₂—Nb₂O₅—R′₂O-based glass powders are those containing 20% to 50% by mass SiO₂, 0% to 10% by mass Li₂O, 0% to 15% by mass Na₂O, 0% to 20% by mass K₂₀, 1% to 30% by mass Li₂O+Na₂O+K₂₀, 1% to 20% by mass B₂O₃, 0% to 10% by mass MgO, 0% to 20% by mass CaO, 0% to 20% by mass SrO, 0% to 15% by mass BaO, 0% to 20% by mass Al₂O₃, 0% to 15% by mass ZnO, 0.01% to 20% by mass TiO₂, 0.01% to 20% by mass Nb₂O₅, 0% to 15% by mass La₂O₃, and 1% to 30% by mass TiO₂+Nb₂O₅+La₂O₃.

The preferred ZnO—B₂O₃—SiO₂-based glass powders are those containing a glass composition of 5% to 60% by mass ZnO, 5% to 50% by mass B₂O₃, and 2% to 30% by mass SiO₂.

The average particle diameter (D₅₀) of the glass powder is preferably not more than 100 μm and particularly preferably not more than 50 μm. If the average particle diameter of the glass powder is too large, the inorganic phosphor powder in the phosphor composite member 5 will be in a poor dispersed condition and the luminescent color will be likely to vary. Note that although no particular limitation is placed on the lower limit of the average particle diameter of the glass powder, it is preferably not less than 0.1 μm and particularly preferably not less than 1 μm because an excessively low average particle diameter thereof will be likely to raise the production cost.

The term “average particle diameter (D₅₀)” herein refers to the value measured by laser diffractometry.

In order to reduce the light scattering loss at the interface between the inorganic base material 2 and the sintered inorganic powder body layer 4, the refractive index difference between them is preferably small. For example, with the use of a YAG ceramic as the inorganic base material 2, the refractive index (nd) of the glass powder is preferably not less than 1.5, more preferably not less than 1.7, and particularly preferably not less than 1.8.

The softening point of the glass powder is preferably not higher than 500° C., more preferably not higher than 450° C., and particularly preferably not higher than 400° C. If the softening point is too high, the sintering temperature will be high, so that the inorganic phosphor powder will be likely to be degraded.

Examples of the inorganic phosphor powder include oxides, nitrides, oxynitrides, sulfides, oxysulfides, oxyfluorides, halides, aluminates, and halophosphoric acid chlorides. Among them, those having an excitation range in a wavelength range of 300 to 500 nm and having a luminescence peak in a wavelength range of 500 to 780 nm, and in particular those for emitting a red light, a yellow light or a green light are preferably used.

Examples of the inorganic phosphor powder which emit a red fluorescence upon irradiation with a blue excitation light include CaS:Eu²⁺; SrS:Eu²⁺; CaAlSiN₃:Eu²⁺; CaSiN₃:Eu²⁺; and (Ca, Sr)₂Si₃N₈:Eu²⁺.

Examples of the inorganic phosphor powder which emits a yellow fluorescence upon irradiation with a blue excitation light include (Sr, Ba, Ca)₂SiO₄:Eu²⁺; (Y, Gd)₃ (Al, Ga)₅O₁₂:Ce³⁺; CaGa₂S₄:Eu²⁺; and La₃Si₆N₁₁:Ce³⁺.

Examples of the inorganic phosphor powder which emits a green fluorescence upon irradiation with a blue excitation light include SrAl₂O₄:Eu²⁺; SrGa₂S₄:Eu²⁺; SrBaSiO₄:Eu²⁺; Ba₃Si₆O₁₂N₂:Eu²⁺; Si₂Al₄O₄N₄:EU²⁺; Sr₃Si₁₃Al₃O₂N₂₁:EU²⁺; Ca₃Sc₂Si₃O₁₂:Ce³⁺; and CaSc₂O₄:Ce³⁺.

The content of inorganic phosphor powder in the sintered inorganic powder body layer 4 is preferably 0.01% to 90% by mass, more preferably 0.05% to 30% by mass, and particularly preferably 0.08% to 15% by mass. If the content of inorganic phosphor powder is too large, the content of glass powder will be relatively small, so that the porosity tends to be large. As a result, the strength of the sintered inorganic powder body layer 4 will be decreased and the light scattering loss will be large. On the other hand, if the content of inorganic phosphor powder is too small, this will make it difficult to provide a sufficient luminescence intensity.

In order to adjust the expansion coefficient of the sintered inorganic powder body layer 4, an inorganic filler powder may be added into the powder mixture 1 (sintered inorganic powder body layer 4). In particular, with the use of a glass powder having a large coefficient of thermal expansion, such as a SnO—P₂O₅-based glass powder, the difference in coefficient of thermal expansion between the inorganic base material 2 and the sintered inorganic powder body layer 4 will be large, so that the surface of the sintered inorganic powder body layer 4 will be likely to cause cracks or likely to be peeled off. Therefore, it is effective to add an inorganic filler powder having a low expansion property to the sintered inorganic powder body layer 4.

Examples of the inorganic filler powder include zirconium phosphate, zirconium phosphotungstate, zirconium tungstate, NZP crystals, and solid solutions of them, all having low expansion properties, and these filler powders can be used singularly or as a mixture. The term “NZP crystals” herein includes crystals having a fundamental structure of Nbzr(PO₄)₃ or [AB₂(MO₄)₃], for example.

A: Li, Na, K, Mg, Ca,Sr, Ba, Zn, Cu, Ni, Mn or the like;

B: Zr, Ti, Sn, Nb, Al, Sc, Y or the like; and

M: P, Si, W, Mo or the like.

The preferred inorganic filler powder used is one containing a Zr component. The reason for this is that the inorganic filler powder containing a Zr component has the characteristic of good compatibility to SnO—P₂O₅-based glasses, i.e., low reactivity with SnO—P₂O₅-based glasses, to make the glass powder less likely to be devitrified during press molding.

The content of inorganic filler powder in the sintered inorganic powder body layer 4 is preferably 0% to 30% by mass, more preferably 1.5% to 25% by mass, and particularly preferably 2% to 20% by mass. If the content of inorganic filler powder is too large, the content of glass powder will be relatively small, so that the mechanical strength will be likely to decrease. Furthermore, the light scattering loss at the interface between the glass matrix and the inorganic filler powder particles will be large, so that the luminescence intensity tends to decrease.

The coefficient of thermal expansion of the inorganic filler powder is, within a temperature range of 30° C. to 380° C., preferably not more than 50×10⁻⁷/° C. and particularly preferably not more than 30×10⁻⁷/° C. If the coefficient of thermal expansion of the inorganic filler powder is too large, this will make it difficult to obtain the effect of reducing the coefficient of thermal expansion of the sintered inorganic powder body layer 4. Note that although no particular limitation is placed on the lower limit of the coefficient of thermal expansion of the inorganic filler powder, it is actually −100×10⁻⁷/° C. or more.

The average particle diameter (D₅₀) of the inorganic filler powder is preferably 0.1 to 50 μm and particularly preferably 3 to 20 μm. If the average particle diameter of the inorganic filler powder is too small, the effect of reducing the coefficient of thermal expansion of the sintered inorganic powder body layer 4 tends to be poor. Otherwise, the inorganic filler powder may be dissolved in glass powder during press molding and may not serve as a filler. If the average particle diameter of the inorganic filler powder is too large, cracks will be likely to occur at the boundary between the glass powder and the inorganic filler powder.

In order to prevent peel-off of the sintered inorganic powder body layer 4 from the inorganic base material 2, the following preferably holds: −5 ppm/° C.≦α1−α2≦5 ppm/° C., particularly—1 ppm/° C.≦α1−α2≦1 ppm/° C., where α1 represents the coefficient of thermal expansion of the inorganic base material 2 and α2 represents the coefficient of thermal expansion of the sintered inorganic powder body layer 4. If (α1−α2) is out of the above range, the sintered inorganic powder body layer 4 will be likely to be peeled off from the inorganic base material 2.

Examples of the inorganic base material 2 include YAG-based ceramics, crystallized glasses, glasses, metals, and metal-ceramic composites. The YAG-based ceramics that can be used are either transparent ones or translucent ones.

In this case, the use of a material capable of transmitting an excitation light and a fluorescence as the inorganic base material 2 makes it possible to provide a white light in combination of, for example, a transmitted light of an excitation light and a fluorescence emitted from the inorganic phosphor powder.

The use of metal or metal-ceramic composite as the inorganic base material 2 makes it possible to provide a reflective phosphor composite member. Examples of the metal include Al, Cu, and Ag. An example of the metal-ceramic composite is a composite (sintered body) of Al and SiC or AlN. If needed, a reflective layer (not shown) made of, for example, Ag or Al may be provided at the interface between the inorganic base material 2 and the sintered inorganic powder body layer 4. Because the metal or metal-ceramic composite has excellent thermal conductivity, it can efficiently radiate heat produced from the phosphor when exposed to a high-intensity excitation light, such as a blue LD, and can therefore reduce the temperature quenching of the inorganic phosphor powder.

Although no particular limitation is placed on the thickness of the inorganic base material 2, it is preferable 0.1 to 10.0 mm, for example. If the thickness of the inorganic base material 2 is too small, the mechanical strength tends to be insufficient. On the other hand, if the thickness of the inorganic base material 2 is too large, the inorganic base material 2 will be less likely to penetrate excitation light, so that the luminescence efficiency tends to decrease or the weight of the phosphor composite member 5 tends to be inappropriately large.

The pressing temperature is preferably not higher than 900° C., more preferably not higher than 700° C., and particularly preferably not higher than 500° C. from the viewpoint of preventing deactivation of the inorganic phosphor powder and denaturation of the glass. On the other hand, because the glass powder must be well softened and thus firmly adhere to a surface of the inorganic base material 2, the lower limit of the pressing temperature is preferably not lower than 200° C. and particularly not lower than 250° C.

The pressure of the pressing is appropriately adjusted within the range of not less than 1 N/mm² or particularly within the range of not less than 3 N/mm² depending upon the desired thickness of the sintered inorganic powder body layer 4. On the other hand, although no particular limitation is placed on the upper limit of the pressure, it is preferably not more than 100 N/mm² and particularly preferably not more than 50 N/mm² in order to prevent breakage of the inorganic base material 2.

Although no particular limitation is placed on the pressing time, it may be appropriately adjusted preferably between 0.1 and 30 minutes, more preferably between 0.5 and 10 minutes, and particularly preferably between 1 and 5 minutes in order that the sintered inorganic powder body layer 4 can sufficiently adhere to the surface of the inorganic base material 2.

Examples of the atmosphere during press molding include air, vacuum, nitrogen, and argon. In order to prevent deactivation of the inorganic phosphor powder, denaturation of the glass powder, and degradation of the press mold due to oxidation, the atmosphere is, among the above, preferably an atmosphere of inert gas, such as nitrogen or argon, particularly a nitrogen atmosphere in consideration of running cost.

The thickness of the sintered inorganic powder body layer 4 is preferably not more than 0.3 mm, more preferably not more than 0.25 mm, and particularly preferably not more than 0.2 mm. If the thickness of the sintered inorganic powder body layer 4 is too large, the excitation light will be less likely to be transmitted, resulting in difficulty in obtaining a light having a desired color. On the other hand, if the thickness of the sintered inorganic powder body layer 4 is too small, the mechanical strength tends to be insufficient. Therefore, the lower limit thereof is preferably not less than 0.01 mm, more preferably not less than 0.03 mm, and particularly preferably not less than 0.05 mm.

The surface roughness (Ra) of the sintered inorganic powder body layer 4 is preferably not more than 0.5 w, more preferably not more than 0.2 w, and particularly preferably not more than 0.1 μm. If the surface roughness of the sintered inorganic powder body layer 4 is too large, the light scattering loss will be large to decrease the transmittance of excitation light and fluorescence, so that the luminescence intensity tends to decrease.

No particular limitation is placed on the shape of the phosphor composite member 5 and examples of the shape include a sheet-like shape, a hemispherical shape, and a hemispherical domed shape.

### EXAMPLES

Hereinafter, the phosphor composite member of the present invention will be described in detail with reference to examples, but is not limited to the examples.

### Example 4

### (1) Production of Ceramic Base Material

First, materials having high purity and a particle diameter of 2 μm or less were used, i.e., 37.4625% by mole Y₂O₃, 62.5% by mole Al₂O₃, and 0.0375% by mole Ce₂O₃ were weighed to give a stoichiometric composition of YAG (Y₃Al₅O₁₂) and 0.6% by mass tetraethoxy silane was added as a sintering additive to these materials. Next, using a ball mil, the prepared materials were mixed with stirring in ethanol for 17 hours, and then dried under reduced pressure to obtain a powder. Subsequently, the resultant powder was press-molded at a pressure of 200 MPa to make a press molded body having a diameter of 10 mm and a thickness of 3 mm, and the press molded body was fired at 1750° C. for 10 hours in a vacuum atmosphere to obtain a sintered body. Thereafter, the sintered body was polished at both surfaces to have a thickness of 0.12 mm, thereby obtaining a ceramic base material.

The ceramic base material thus obtained was identified in terms of its precipitated crystals using an X-ray powder diffractometer. Asa result, it was confirmed that YAG crystals were precipitated in a single phase.

Furthermore, the obtained YAG ceramic base material was measured in terms of luminescence spectra. As a result, peaks were observed which were derived from a yellow fluorescence having a center wavelength near 550 nm and a blue excitation light (an excitation light having penetrated the ceramic base material) having a center wavelength near 465 nm.

### (2) Production of Phosphor Composite Member

The glass powder, inorganic phosphor powder and inorganic filler powder described in Table 2 were mixed in a predetermined ratio to produce a powder mixture.

The glass powder was produced in the following manner. First, glass materials prepared to give a composition described in Table 2 were put into an alumina crucible and melted at 950° C. for an hour in an electric furnace and in a nitrogen atmosphere. Thereafter, the glass melt was formed into a film and then ground by a mortar to obtain a glass powder. The average particle diameter (D₅₀) of the obtained powder was 32 μm.

The YAG ceramic base material obtained in (1) was placed still on a hot plate and a predetermined amount of the powder mixture was put on the base material. Next, a mold was pressed against the powder mixture and the powder mixture was press molded at the pressure and pressing temperature described in Table 2 in a nitrogen atmosphere for three minutes to form a sintered inorganic powder body layer on a surface of the YAG ceramic base material, thereby obtaining a phosphor composite member.

### (3) Measurement of Total Flux and Chromaticity

The phosphor composite member thus obtained was measured in terms of luminescence spectra in the following manner. The phosphor composite member was excited, in a calibrated integrating sphere, by a blue LED illuminated by an electric current of 200 mA and the resultant luminescence was retrieved through an optical fiber into a small spectrometer (USB4000 manufactured by Ocean Optics, Inc.) to obtain luminescence spectra (an energy distribution curve) on a control PC. The total flux and chromaticity were calculated from the obtained luminescence spectra. The results are shown in Table 2.

### Comparative Example 2

### (1) Production of Paste for Sintered Inorganic Powder Body Layer

The glass powder, inorganic phosphor powder and inorganic filler powder described in Table 2 were mixed in a predetermined ratio to produce a powder mixture. Next added to 100 mass parts of the obtained powder mixture was 50 mass parts of 2,4-diethyl-1,5-pentanediol (MARS manufactured by The Nippon Koryo Yakuhin Kaisha, Ltd.) as a solvent, followed by mixing to obtain a paste.

### (2) Production of Phosphor Composite Member

The paste for the sintered inorganic powder body layer obtained in (1) above was coated by dispensing on a surface of the YAG ceramic base material obtained in Example 4 to have a thickness of approximately 300 μm. Next, the solvent was removed from the coating by subjecting the coating to thermal treatment on a hot plate at approximately 250° C. Thereafter, the coating was fired at 430° C. for 10 minutes in a nitrogen atmosphere and its surface shape was fixed by hot pressing at a pressure of 1 N/mm² to obtain a phosphor composite member.

The phosphor composite member thus obtained was measured in terms of total flux and chromaticity in the same manner as in Example 4. The results are shown in Table 2. As is evident from Table 2, the phosphor composite member obtained in Comparative Example 2 exhibited a poorer total flux than Example 4.

### Comparative Example 3

### (1) Production of Green Sheet for Sintered Inorganic Powder Body Layer

The glass powder and inorganic phosphor powder described in Table 2 were mixed in a predetermined ratio to produce a powder mixture. Next added to 100 mass parts of the powder mixture were 12 mass parts of polyvinyl butyral resin as a binder, 3 mass parts of dibutyl phthalate as a plasticizer, and 40 mass parts of toluene as a solvent, followed by mixing to produce a slurry. Subsequently, the slurry was formed into a sheet on a PET film by a doctor blade method and then dried to obtain a green sheet having a thickness of 250 μm.

### (2) Production of Phosphor Composite Member

The green sheet produced in (1) above was laid on the YAG ceramic base material obtained in Example 4 and integrated together by thermocompression bonding to produce a laminate and the laminate was then degreased at 350° C. for an hour. Next, the laminate was fired at 400° C. for 20 minutes and then cooled to obtain a phosphor composite member.

The phosphor composite member thus obtained was measured in terms of total flux and chromaticity in the same manner as in Example 4. The results are shown in Table 2. As is evident from Table 2, like Comparative Example 2, the phosphor composite member obtained in Comparative Example 3 exhibited a poorer total flux than Example 4.

### Example 5

The glass powder, inorganic phosphor powder and inorganic filler powder described in Table 2 were mixed in a predetermined ratio to produce a powder mixture.

The glass powder was produced in the following manner. First, glass materials prepared to give a composition of 72% by mole SnO and 28% by mole P₂O₅ were put into an alumina crucible and melted at 950° C. for an hour in an electric furnace and in a nitrogen atmosphere. Thereafter, the glass melt was formed into a film and then ground by a mortar to obtain a glass powder. The average particle diameter (D₅₀) of the obtained powder was 36 μm.

The YAG ceramic base material obtained in Example 4 was placed still on a hot plate and a predetermined amount of the powder mixture was put on the base material. Next, a mold was pressed against the powder mixture and the powder mixture was press molded at the pressure and pressing temperature described in Table 2 in a nitrogen atmosphere for three minutes to form a sintered inorganic powder body layer on a surface of the YAG ceramic base material, thereby obtaining a phosphor composite member.

The phosphor composite member thus obtained was measured in terms of total flux and chromaticity in the same manner as in Example 4. The results are shown in Table 2.

TABLE 2

| | | Example 4 | Comp. Ex. 2 | Comp. Ex. 3 | Example 5 |
|---|---|---|---|---|---|
| Glass Powder Composition | | 62SnO—21.5P₂O₅—11B₂O₃—3MgO—2.5Al₂O₃ | | | 72SnO—28P₂O₅ |
| [% by mole] | | | | | |
| Inorganic Phosphor Powder | | CaAlSiN₃:Eu²⁺ | | | |
| Inorganic Filler Powder | | NbZr(PO₄)₂ | | Nothing | NbZr(PO₄)₃ |
| Glass Powder to Inorganic | | 80:10:10 | | 90:10:0 | 79:12:9 |
| Phosphor Powder to Inorganic | | | | | |
| Filler Powder [mass ratio] | | | | | |
| Inorganic Base Material | | YAG ceramic | | | |
| Production Method | | Press molding | Dispensing | Green sheet | Press molding |
| | | | | process | |
| Pressing | Pressure [N/mm²] | 12 | — | — | 6 |
| Conditions | Temperature [° C.] | 420 | — | — | 315 |
| Thickness of Sintered Inorganic | | 0.015 | 0.13 | 0.12 | 0.037 |
| Powder Body Layer [mm] | | | | | |
| Chroma- | x | 0.37 | 0.42 | 0.41 | 0.41 |
| ticity | y | 0.44 | 0.41 | 0.42 | 0.44 |

| | | | | |
|---|---|---|---|---|
| Total Flux [lm] | 0.0217 | 0.0165 | 0.0162 | 0.0202 |

### Examples 6 to 9

The glass powder, inorganic phosphor powder and inorganic filler powder described in Table 3 were mixed in a predetermined ratio to obtain a powder mixture.

A cover glass substrate (manufactured by Matsunami Glass Ind., Ltd.) with a thickness of 0.15 mm was placed still on a hot plate and a predetermined amount of the powder mixture was put on the substrate. Next, a mold was pressed against the powder mixture and the powder mixture was press molded at the pressure and pressing temperature described in Table 3 in a nitrogen atmosphere for three minutes to form a sintered inorganic powder body layer on a surface of the cover glass base material, thereby obtaining a phosphor composite member.

The phosphor composite member thus obtained was measured in terms of total flux and chromaticity in the same manner as in Example 4. The results are shown in Table 3.

TABLE 3

| | | Example 6 | Example 7 | Example 8 | Example 9 |
|---|---|---|---|---|---|
| Glass Powder Composition | | 62SnO—21.5P₂O₅—11B₂O₃—3MgO—2.5Al₂O₃ | | 72SnO—28P₂O₅ | |
| [% by mole] | | | | | |
| Inorganic Phosphor Powder 1 | | (Y,Gd)₃Al₅O₁₂:Ce³⁺ | SrBaSiO₄:Eu²⁺ | (Y,Gd)₃Al₅O₁₂:Ce³⁺ | SrBaSiO₄:Eu²⁺ |
| Inorganic Phosphor Powder 2 | | CaAlSiN₃:Eu²⁺ | | | |
| Glass Powder to Inorganic | | 88:9:3 | | 81:14:5 | |
| Phosphor Powder 1 to Inorganic | | | | | |
| Phosphor Powder 2 [mass ratio] | | | | | |
| Inorganic Base Material | | Cover glass | | | |
| Production Method | | Press molding | | | |
| Pressing | Pressure [N/mm²] | 6 | 6 | 1 | 6 |
| Conditions | Temperature [° C.] | 410 | 400 | 315 | 310 |
| Thickness of Sintered Inorganic | | 0.08 | 0.11 | 0.084 | 0.11 |
| Powder Body Layer [mm] | | | | | |
| Chroma- | x | 0.39 | 0.28 | 0.37 | 0.37 |
| ticity | y | 0.29 | 0.19 | 0.30 | 0.27 |

| | | | | |
|---|---|---|---|---|
| Total Flux [lm] | 0.0125 | 0.0110 | 0.0148 | 0.0118 |

### Comparative Example 4

The glass powder and inorganic phosphor powder described in Table 4 were mixed in a predetermined ratio to obtain a powder mixture.

A predetermined amount of the powder mixture was put directly on a hot plate, a mold was pressed against the powder mixture, and the powder mixture was press molded at the pressure and pressing temperature described in Table 4 in a nitrogen atmosphere for three minutes to form a sintered inorganic powder body layer.

The sintered inorganic powder body layer was very brittle and it was broken when removed from the hot plate. Therefore, it could not be measured in terms of total flux and chromaticity.

TABLE 4

| | | Comp. Ex. 4 |
|---|---|---|
| Glass Powder | | 62SnO—21.5P₂O₅—11B₂O₃—3MgO—2.5Al₂O₃ |
| Composition | | |
| [% by mole] | | |
| Inorganic Phosphor | | (Y,Gd)₃Al₅O₁₂:Ce³⁺ |
| Powder | | |
| Glass Powder to | | 75:25 |
| Inorganic Phosphor | | |
| Powder [mass ratio] | | |
| Inorganic Base | | Nothing |
| Material | | |
| Production Method | | Press molding |
| Pressing | Pressure | 2 |
| Conditions | [N/mm²] | |
| | Temper- | 405 |
| | ature | |
| | [° C.] | |
| Thickness of | | 0.16 |
| Sintered Inorganic | | |
| Powder Body | | |
| Layer [mm] | | |
| Chroma- | x | Unmeasurable |
| ticity | y | because of |

| | |
|---|---|
| Total Flux [lm] | breakage |

### INDUSTRIAL APPLICABILITY

The phosphor composite member of the present invention is not limited to an application for an LED but can also be used as a wavelength conversion member in an LED device capable of emitting a high-power excitation light, such as a laser diode.

### REFERENCE SIGNS LIST

1 . . . powder mixture
2 . . . inorganic base material
3a . . . upper mold half
3b . . . lower mold half
4 . . . sintered inorganic powder body layer
5 . . . phosphor composite member
P . . . direction of pressure application
11 . . . sintered inorganic powder body layer
12 . . . ceramic base material

1. A phosphor composite member in which a sintered inorganic powder body layer containing a SnO—P₂O₅-based glass and an inorganic phosphor powder is formed on a surface of a ceramic base material, wherein upon irradiation with an excitation light, the ceramic base material and the sintered inorganic powder body layer emit different fluorescences having different wavelengths.

2. The phosphor composite member according to claim 1, wherein the ceramic base material absorbs an excitation light in a wavelength range of 400 to 500 nm and emits a fluorescence in a wavelength range of 450 to 780 nm.

3. The phosphor composite member according to claim 2, wherein the ceramic base material absorbs a blue excitation light and emits a yellow fluorescence.

4. The phosphor composite member according to claim 1, wherein the ceramic base material is made of garnet crystals containing Ce³⁺ in the crystal.

5. The phosphor composite member according to claim 4, wherein the garnet crystal is a YAG crystal or a YAG crystalline solid solution.

6. The phosphor composite member according to claim 1, wherein the sintered inorganic powder body layer absorbs an excitation light in a wavelength range of 400 to 500 nm and emits a fluorescence in a wavelength range of 500 to 780 nm.

7. The phosphor composite member according to claim 6, wherein the sintered inorganic powder body layer absorbs a blue excitation light and emits a red fluorescence and/or a green fluorescence.

8. The phosphor composite member according to claim 1, wherein the fluorescences emitted from the ceramic base material and the sintered inorganic powder body layer and the excitation light penetrating through the phosphor composite member are synthesized to emit a white light.

9. The phosphor composite member according to claim 1, wherein the sintered inorganic powder body layer contains the inorganic phosphor powder in a proportion of 0.01% to 30% by mass.

10. The phosphor composite member according to claim 1, wherein the SnO—P₂O₅-based glass contains as a composition 35% to 80% by mole SnO, 5% to 40% by mole P₂O₅, and 0% to 30% by mole B₂O₃.

11. The phosphor composite member according to claim 1, wherein the sintered inorganic powder body layer has a surface roughness Ra of 0.5 μm or less.

12. The phosphor composite member according to claim 1, wherein the phosphor composite member has a scattering coefficient of 1 to 500 cm⁻¹.

13. An LED device using the phosphor composite member according to claim 1.

14. A method for manufacturing the phosphor composite member according to claim 1, the method comprising the steps of: firing a mixture of a SnO—P₂O₅-based glass and an inorganic phosphor powder to obtain a sintered body; and pressing the sintered body against the ceramic base material by thermocompression bonding to form a sintered inorganic powder body layer.

15. A method for manufacturing a phosphor composite member, the method comprising the steps of: placing a powder mixture containing a glass powder and an inorganic phosphor powder on an inorganic base material; and press molding the powder mixture with application of heat using a mold to form a sintered inorganic powder body layer on a surface of the inorganic base material.

16. The method for manufacturing a phosphor composite member according to claim 15, wherein the inorganic base material is made of YAG-based ceramic, crystallized glass, glass, metal or a metal-ceramic composite.

17. The method for manufacturing a phosphor composite member according to claim 15, wherein the sintered inorganic powder body layer has a thickness of 0.3 mm or less.

18. The method for manufacturing a phosphor composite member according to claim 15, wherein the sintered inorganic powder body layer has a surface roughness (Ra) of 0.5 μm or less.

19. The method for manufacturing a phosphor composite member according to claim 15, wherein the glass powder has an average particle diameter (D₅₀) of 100 μm or less.

20. The method for manufacturing a phosphor composite member according to claim 15, wherein the proportion of the inorganic phosphor powder in the sintered inorganic powder body layer is 0.01% to 90% by mass.

21. The method for manufacturing a phosphor composite member according to claim 15, wherein the sintered inorganic powder body layer contains 0% to 30% by mass inorganic filler.

22. The method for manufacturing a phosphor composite member according to claim 15, wherein the glass powder is a SiO₂—B₂O₃—RO-based glass powder (where R is one or more elements selected from Mg, Ca, Sr, and Ba), a SiO₂—TiO₂—Nb₂O₅—R′₂O-based glass powder (where R′ is one or more elements selected from Li, Na, and K), a SnO—P₂O₅-based glass powder, or a ZnO—B₂O₃—SiO₂-based glass powder.

23. The method for manufacturing a phosphor composite member according to claim 22, wherein the SnO—P₂O₅-based glass powder contains as a glass composition 35% to 80% by mole SnO, 5% to 40% by mole P₂O₅, and 0% to 30% by mole B₂O₃.

24. The method for manufacturing a phosphor composite member according to claim 15, wherein the inorganic phosphor powder is an oxide, a nitride, an oxynitride, a sulfide, an oxysulfide, an oxyfluoride, a halide, an aluminate, or a halophosphoric acid chloride.

25. The method for manufacturing a phosphor composite member according to claim 15, wherein the temperature during press molding is 900° C. or below.

26. The method for manufacturing a phosphor composite member according to claim 15, wherein the atmosphere during press molding is air, vacuum, nitrogen or argon.

27. The method for manufacturing a phosphor composite member according to claim 15, wherein the shape of the phosphor composite member is a sheet-like shape, a hemispherical shape, or a hemispherical domed shape.

28. A phosphor composite member produced by the manufacturing method according to claim 15.
